(19) United States
(12) Patent Application Publication
(10) Pub. No.: US 2022/0347511 A1
(43) Pub. Date: Nov. 3, 2022

(54) STRETCHING DEVICE AND METHODS

(71) Applicant: ForeLife Designs, LLC., East Norwich, NY (US)

(72) Inventor: John Giacinto, Garden City, NY (US)

(73) Assignee: ForeLife Designs, LLC., East Norwich, NY (US)

(21) Appl. No.: 17/732,795

(22) Filed: Apr. 29, 2022

Related U.S. Application Data
(60) Provisional application No. 63/182,374, filed on Apr. 30, 2021.

(51) Int. Cl. A63B 21/04; A63B 21/055; A63B 23/16

(52) U.S. Cl. CPC A63B 21/0442; A63B 21/0552; A63B 23/16

(57) ABSTRACT

This disclosure provides devices and methods for stretching that include an anchor configured to attached to a force providing element; a support, the anchor operably attached to the support; a plurality of finger traps operably attached to the support; and a wrist cuff operably attached to the support.

### CROSS-REFERENCE TO RELATED APPLICATIONS

This application claims the benefit of priority of U.S. Provisional Application No. 63/182,374, filed Apr. 30, 2021, the entire contents of which are incorporated herein by reference.

### BACKGROUND OF THE DISCLOSURE

Stretching is an important part of exercise, rehabilitation and/or fitness routines. It is further an important component of physical therapy and sports medicine. Stretching reduces tissue injury, improves flexibility, helping joints move through their full range of motion and increases blood flow to muscles. Those who regularly work out including athletes understand the benefits of stretching and improving body flexibility as well as range of motion during exercise programs and to perform certain elements during competitive routines. Some methods involve stretching without any device by using one's own body or applying tension on an external stationary object, while some methods involve use of an apparatus. Stretching can be performed slowly and steadily, in a controlled manner, to reduce injuries such as muscle or ligament tearing. Stretching can also be performed for required duration to prevent tissue injury and improve flexibility.

Some existing methods and devices for stretching do not maximize the benefits of appropriate stretching and can actually cause side effects due to improper form, inability to customize and misalignment of the body.

Accordingly, there is a need for a stretching device that can be customized for a specific person's needs. Embodiments of the present disclosure provide devices and methods that address the above needs.

### SUMMARY OF THE DISCLOSURE

This disclosure provides devices and methods for stretching that include an anchor configured to attached to a force providing element; a support, the anchor operably attached to the support; a plurality of finger traps operably attached to the support; and a wrist cuff operably attached to the support.

### BRIEF DESCRIPTION OF THE DRAWINGS

FIG. 1 is a view of the elements of the stretching device

FIG. 2 is a view of the support and attached cords.

FIG. 3 is a view of the support and the wrist cuff.

FIG. 4 is a view of the finger traps.

FIG. 5 is a view of one example of use of the stretching device.

### DETAILED DESCRIPTION OF THE DISCLOSURE

In the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein.

As used herein, the term “substantially”, or “substantial”, is a broad term and is used in its ordinary sense, including, without limitation, being largely but not necessarily wholly that which is specified, which is equally applicable when used in a negative connotation to refer to the complete or near complete lack of an action, characteristic, property, state, structure, item, or result. For example, a surface that is “substantially” flat would mean either completely flat, or so nearly flat that the effect would be the same as if it were completely flat.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

The terms “a and “an” as used herein unless clearly indicated to the contrary, should be understood to mean one, but also possibly more than one. The term “or”, as used herein means inclusively in the alternative.

As used herein, the phrase “at least one” in reference to one or more elements, should be understood to mean at least one element selected from any one or more of the elements in the list of elements, but not necessarily including at least one of each and every element specifically listed within the list of elements and not excluding any combinations of elements in the list of elements. Meaning that elements may optionally be present other than the elements specifically identified within the list of elements that the phrase “at least one” refers to, whether related or unrelated to those elements specifically identified.

References in the specification to “one embodiment”, “an embodiment”, “an instance”, “an example”, etc., indicate that the embodiment described may include a particular feature or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. For purposes of the description hereinafter, the terms “upper”, “lower”, “right”, “left”, “vertical”, “horizontal”, “top”, “bottom”, and derivatives thereof shall relate to the invention, as it is oriented in the drawing figures. The terms “on”, “overlying”, “atop”, “positioned on” or “positioned atop” means that a first element, is present on a second element, wherein intervening elements may interface between the first element and the second element. The term “ajoined”, “direct contact”, “connected to”, “affixed to” or “attached to” means that a first element, and a second element, are connected without any intermediary element at the interface of the two elements.

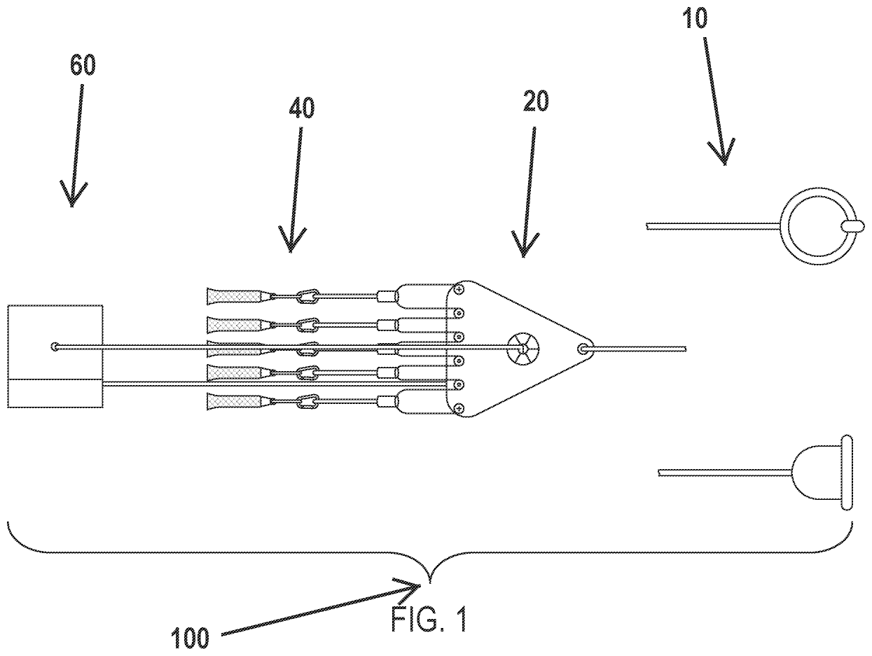

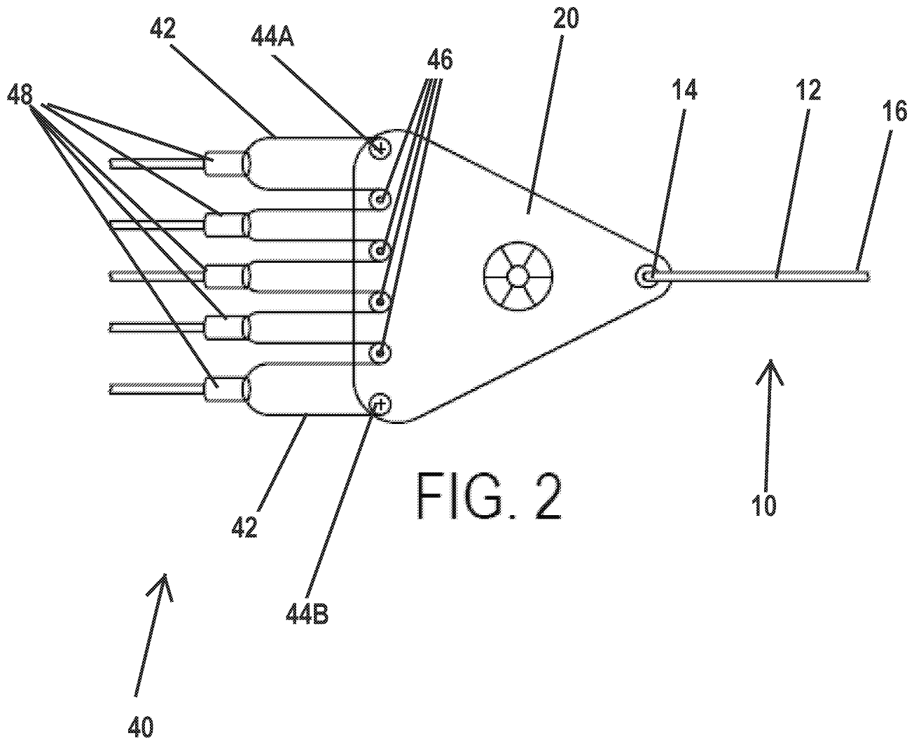

An embodiment of a stretching device 100 is shown in FIG. 1. As seen in FIG. 1, the stretching device 100 can include an anchor 10 that is configured to attach to a force providing element, a support 20, with the anchor 10 operably attached to the support 20, a plurality of finger traps 40, with each of those plurality of finger traps 40 operably attached to the support, and a wrist cuff 60, the wrist cuff 60 being operably attached to the support 20. These elements are discussed and shown in further detail in FIGS. 2-5, discussed below.

As seen in FIG. 2, the anchor 10 includes an anchor cord 12, with a first end of the anchor cord 14 being operably attached to the support 20, and a second end of the anchor cord 16 configured to attach to a force providing element. This force providing element can be any element that can remain fixed or substantially fixed upon receiving a body weight force, such as but not limited to a door, a door frame, a beam, a strut, etc. Additionally, or alternatively, this force providing element can be another person pulling the second end of the anchor cord 16. The second end of the anchor cord 16 can be attached to the force providing element in any suitable way, with any suitable connection, such as a ring connection or a suction element connection, or a handle connection, with the ring connection and handle connection both shown in FIG. 1.

The anchor cord 12 can be formed of any suitable material, with that suitable material being selected from elastic materials, inelastic materials or substantially inelastic materials. As used herein the term elastic, or any derivative thereof, is a broad term and can refer to a material that is substantially deformable and able to be bent, unbent, expanded, contracted, folded, unfolded, or otherwise substantially deformed or caused to change shape upon application of a force.

As used herein the term inelastic”, or any derivative thereof, is a broad term used in its ordinary sense and refers to the flexural rigidity of a material that generally avoids substantial deformation and/or maintains very close to its original form after pressure has been applied to it.

Examples of the material of the anchor cord 12 include but are not limited to man-made an/or natural materials, such as plastic, glass, ceramic, metal(s), carbon-based materials, elastomer, rubber, rope, cable, thread, wire, string, chain, twisted twine, twisted mason line, synthetic fibers, fishing line, sisal, coconut fiber and combinations thereof.

As can also be seen in FIG. 2, a finger trap cord 42 is operably attached to the support 20. The finger trap cord 42 can be one cord, or finger trap cord 42 can be two or more cords linked together. Five finger trap connectors 48 are connected to the finger trap cord 42. Although five finger trap connectors 48 are shown in FIG. 2, in other embodiments, one, two, three, four, six, seven, eight, nine, ten or more finger trap connectors 48 can be operably attached to the support 20.

The finger trap cord 42 can be formed of any suitable material, with that suitable material being selected from elastic materials, inelastic materials or substantially inelastic materials. Examples of the material of the finger trap cord 42 include but are not limited to man-made an/or natural materials, such as plastic, glass, ceramic, metal(s), carbon-based materials, elastomer, rubber, rope, cable, thread, wire, string, chain, twisted twine, twisted mason line, synthetic fibers, fishing line, sisal, coconut fiber and combinations thereof.

In the embodiment of FIG. 2, the support 20 includes two finger trap cord fasteners 44A and 44B and four finger trap cord pulleys 46. The finger trap cord 42 is fastened at one end to the finger trap cord fastener 44A, the finger trap cord 42 is fastened at the other end to the finger trap cord fastener 44B. The finger trap cord 42 passes from the finger trap cord fastener 44A, to one of the finger trap connectors 48, past a finger trap pulley 46, to another of the finger trap connectors 48, pas another finger trap pulley 46, etc, until the finger trap cord is fastened at the finger trap cord fastener 44B. Each of the finger trap pulleys 46 are freely rotatable in both the clockwise and counter-clockwise directions which, during use of the device 100, can operate to equalize or substantially equalize a force of each of the finger traps 40. Additionally, or alternatively, a tension and/or force of each of the finger traps 40 can be modified as compared to tension and/or force of the other finger traps 40 though any additional fasteners to modify any length of the finger trap cord 42. Further still, additionally, or alternatively, the finger trap cord 42 can include a plurality of cords with two or more of the finger traps 40 being operably attached to a dedicated finger trap cord 42 of a fixed length.

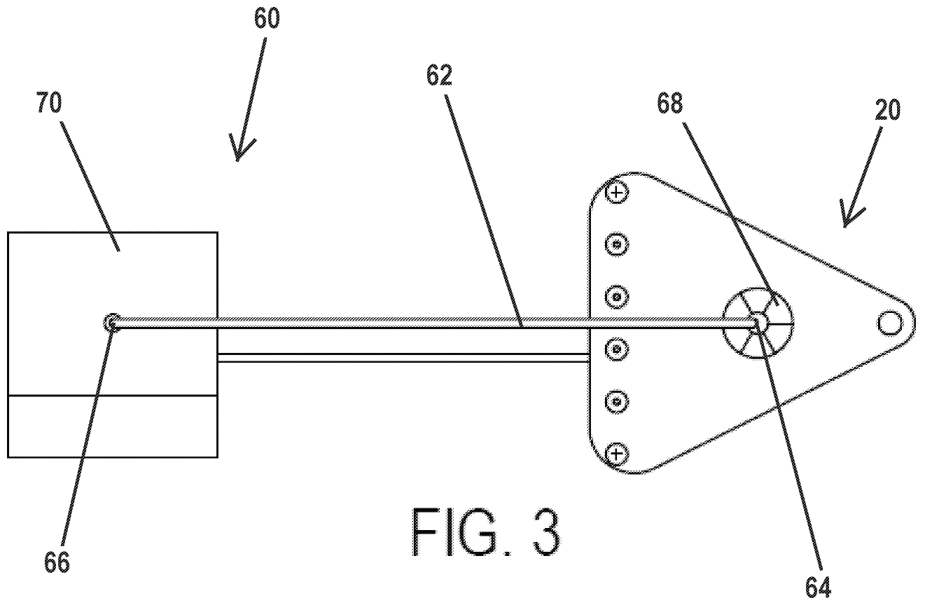

The wrist cuff 60 is shown in more detail in FIG. 3. As can be seen in FIG. 3, a wrist cuff cord 62 operably attaches the wrist cuff band 70 to the support 20, and operably attaches the wrist cuff band 70 to a wrist tensioner 68. Specifically, a first end of the wrist cuff cord 64 is operably attached to the wrist tensioner 68 and a second end of the wrist cuff cord 64 is operably attached to a wrist cuff band 70.

The wrist cuff cord 62 can be formed of any suitable material, with that suitable material being selected from elastic materials, inelastic materials or substantially inelastic materials. Examples of the material of the finger trap cord 42 include but are not limited to man-made an/or natural materials, such as plastic, glass, ceramic, metal(s), carbon-based materials, elastomer, rubber, rope, cable, thread, wire, string, chain, twisted twine, twisted mason line, synthetic fibers, fishing line, sisal, coconut fiber and combinations thereof.

The wrist cuff band 70 is configured to extend around a portion of a person's body, including but not limited to a wrist, an arm, a leg, a foot, a toe, a neck, a torso, etc., The wrist cuff band 70 is configured to maintain a desired perimeter (circumference) through a suitable locking mechanism, such as but not limited to a hook and loop mechanism, a belt mechanism, and a ratchet mechanism.

The second end of the wrist cuff cord 64 is operably attached to the wrist tensioner 68. The wrist tensioner 68 is any suitable device that can modulate, and maintain under tension, the length of the wrist cuff cord 62 between the second end of the wrist cuff cord 64 and the wrist tensioner 64. This wrist tensioner 68 allows for a customized pressure between the user's wrist as compared to the user's fingers in the finger trap 40.

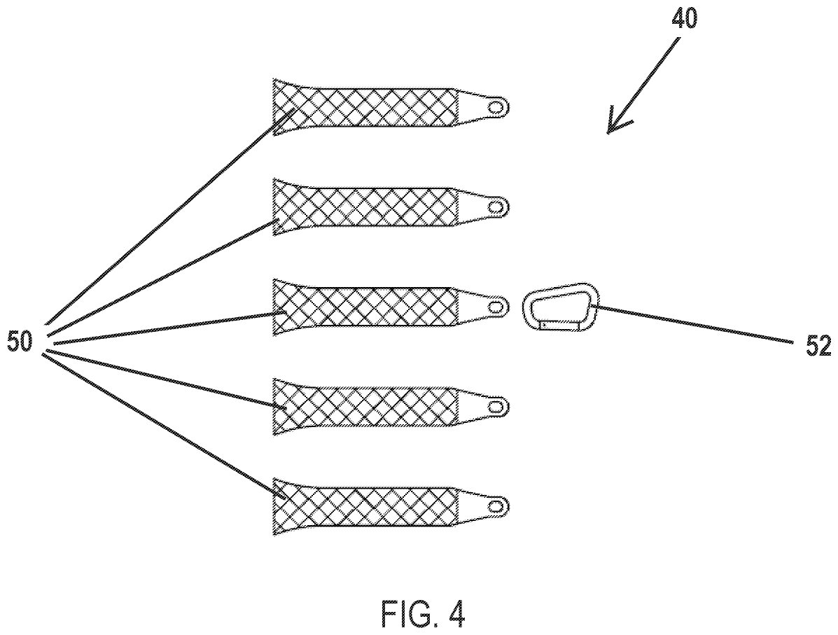

Portions of the finger trap 40 are shown in more detail in FIG. 4. FIG. 4 illustrates five single finger traps 50, however, in other embodiments, one, two, three, four, six, seven, eight, nine, ten or more single finger traps 50 can be included.

Each single finger trap 50 is operably connected, such as by a clip 52 (only one shown for illustrative purposes), to a respective finger trap connector 48 (as shown in FIG. 2). Each single finger trap 50 can be of any suitable size to extend around a person's digit (finger or toe, as desired). Each single finger trap 50 can be formed of a suitable material, such as man-made an/or natural materials, such as plastic, glass, ceramic, metal(s), carbon-based materials, elastomer, rubber, rope, cable, thread, wire, string, chain, twisted twine, twisted mason line, synthetic fibers, fishing line, sisal, coconut fiber and combinations thereof.

Each single finger trap 50 can be any suitable structure that, during engagement, can distribute a pressure load and/or traction to an elongated periphery of a user's digit in response to a pressure received in the direction of the respective finger trap connector 48. Each single finger trap 50 can be disengaged in any suitable way, such as applying a pressure in a direction opposite or substantially opposite to the respective finger trap connector 48.

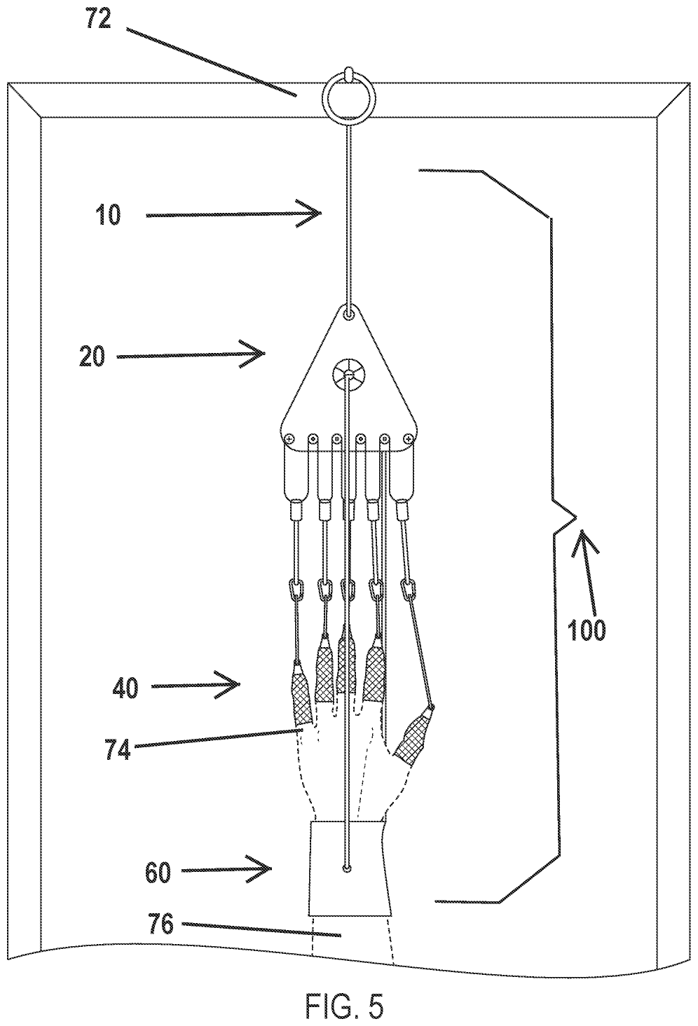

Use of the device 100 is discussed in reference to FIG. 5. In FIG. 5 the anchor 10 is operably attached to a portion of a door frame 72, with the portion of the door frame 72 acting as the force providing element in this example. A user has placed their hand, so that each finger 74 is extended into a respective finger trap of the plurality of finger traps 40. The user has also placed their arm 76 through the wrist cuff 60, with the size/perimeter of the wrist cuff 60 being set for the specific user's wrist dimensions. The wrist tensioner 68 of the support 20 is adjusted so that when the user applies force vertically downwards in FIG. 5, the appropriate tension is applied to both the wrist 76 by the wrist cuff 60, as well as to each finger 74 by the plurality of finger traps 40. The user can continue to apply force vertically downward in FIG. 5 by leaning away from the door frame 72, or pulling their arm away from the door frame 72, for any suitable amount of time. This applied force can stretch or pull any and all ligaments, tendons, muscles, joints, fascia, etc. in the user's hand, wrist and arm.

The device 100 can be used as shown in FIG. 5 for relief of physical pain for upper extremities including finger joints, wrist, forearm, elbow, bicep and triceps tendons/ligaments, shoulder, rotator cuff; also including neck, back, and chest based on how the user moves their arm into different positions. The device 100 can be used as shown in FIG. 5 can be used in treatment of any medically diagnosed or non-diagnosed recurring or intermittent conditions. Some examples of diagnosed disorders that the device 100 may help alleviate are: Tendonitis, Arthritis, Gout, Carpel Tunnel, Rheumatoid Arthritis, Trigger Finger, Bursitis, Tennis Elbow, Golf Elbow, Frozen Shoulder (limitations in shoulder mobility), Ulnar Nerve related issues, etc.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

What is claimed is:

1. A stretching device comprising:
an anchor configured to attached to a force providing element;
a support, the anchor operably attached to the support;
a plurality of finger traps operably attached to the support; and
a wrist cuff operably attached to the support.

2. The device of claim 1, wherein the anchor is configured to attach to the force providing element with an anchor cord.

3. The device of claim 2, wherein the anchor cord is formed of an anchor cord material, and the anchor cord material is selected from the group consisting of a elastic material, an inelastic material, and a substantially inelastic material.

4. The device of claim 1, wherein the force providing element is a fixed structure.

5. The device of claim 1, wherein the wrist cuff is operably attached to the support with a wrist cuff cord.

6. The device of claim 5, wherein the wrist cuff cord is formed of a wrist cuff cord material, and the wrist cuff cord material is selected from the group consisting of a elastic material, an inelastic material, and a substantially inelastic material.

7. The device of claim 5, wherein the support further comprises a wrist tensioner, and wherein a first end of the wrist cuff cord is operably attached to the wrist cuff cord and a second end of the wrist cuff cord is operably attached to the wrist tensioner.

8. The device of claim 1, wherein each of the plurality of finger traps is operably attached to the support with a finger trap cord.

9. The device of claim 8, wherein the finger trap cords is formed of a finger trap cord material, and the finger trap cord material is selected from the group consisting of a elastic material, an inelastic material, and a substantially inelastic material.
